(19) United States
(12) Patent Application Publication
(10) Pub. No.: US 2011/0108159 A1
(43) Pub. Date: May 12, 2011

(54) VAPOR VALVE FOR STORAGE TANK

(75) Inventor: Brandon P. Grote, Cincinnati, OH (US)

(73) Assignee: DELAWARE CAPITAL FORMATION, INC., Wilmington, DE (US)

(21) Appl. No.: 12/941,341

(22) Filed: Nov. 8, 2010

Related U.S. Application Data
(60) Provisional application No. 61/259,755, filed on Nov. 10, 2009.
(60) Provisional application No. 61/266,809, filed on Dec. 4, 2009.

(51) Int. Cl. F16K 24/04

(52) U.S. Cl. 141/4; 137/199

(57) ABSTRACT

A tank assembly including a tank for storing fluid, the tank having a fluid refill path. The assembly includes a blocking valve coupled to the tank, the blocking valve being positioned in the fluid refill path and configured to selectively generally seal the fluid refill path. The assembly further includes an overfill valve in fluid communication with the fluid refill path and configured to generally block the fluid refill path when sufficient fluid is in the tank. The blocking valve is positioned to prevent vapors which are introduced into the fluid refill path via the overfill valve from escaping from the tank.

This application claims priority to U.S. Provisional Patent Application No. 61/259,755, filed on Nov. 10, 2009 and U.S. Provisional Patent Application No. 61/266,809, filed on Dec. 4, 2009. The entire contents of both of those applications are incorporated herein by reference.

The present invention is directed to a valve for use with a storage tank, and more particularly, to valve which configured to block the escape of vapors from the storage tank.

### BACKGROUND

Fuel tank couplings are typically positioned on associated fuel tanks for use in storing large amounts of fuel, such as at refueling stations. The fuel tank coupling provides a secure engagement with the refill hose/dispensing line to form a fluid-tight seal during refilling operations. However, existing fuel tank couplings may be configured such that when refueling operations are not being carried out, a fluid path is provided from the tank to the ambient environment, thereby allowing vapors to escape from the tank.

### SUMMARY

In one embodiment the present invention is a tank system including a valve which seals the tank's fluid path to thereby prevent vapors from escaping from the tank. More particularly, in one embodiment the invention is a tank assembly including a tank for storing fluid, the tank having a fluid refill path. The assembly includes a blocking valve coupled to the tank, the blocking valve being positioned in the fluid refill path and configured to selectively generally seal the fluid refill path. The assembly further includes an overfill valve in fluid communication with the fluid refill path and configured to generally block the fluid refill path when sufficient fluid is in the tank. The blocking valve is positioned to prevent vapors which are introduced into the fluid refill path via the overfill valve from escaping from the tank.

In another embodiment the invention is a coupling system including a tank coupling coupled to a tank and configured to be coupled to a nozzle coupling to allow fluid to flow therethrough and into the tank. The tank coupling includes a tank coupling valve movable between a closed position in which the tank coupling valve generally blocks the flow of fluids therethrough and an open position in which the tank coupling valve generally does not block the flow of fluids therethrough. The tank coupling valve is configured to be moved from the closed position to the open position by a force other than a pressure of fluid flowing therethrough.

### BRIEF DESCRIPTION OF DRAWINGS

FIG. 1 is a front perspective view of a refilling tank truck in conjunction with a storage tank, with portions of the tank and spill bucket cut away;

FIG. 2 is a side cross section of part of the storage tank of FIG. 1;

FIGS. 3A-3C are side cross sections illustrating various configurations of tank couplings in combination with an overfill valve;

FIG. 4 is a side cross section of the tank coupling of FIG. 2, with a nozzle coupling positioned adjacent thereto;

FIG. 5 is a side cross section of the tank coupling and nozzle coupling of FIG. 4, coupled together and with the locking arms in a retracted position;

FIG. 6 is a side cross section of the tank coupling and nozzle coupling of FIG. 5, with the locking arms in an engaged position;

FIG. 7 is a side cross section of the tank coupling and nozzle coupling of FIG. 6, in a view rotated 90 degrees about the central axis;

FIG. 8 is a side cross section of the tank coupling and nozzle coupling of FIG. 6, with the actuator handle rotated and the couplings moved to their open positions;

FIG. 9 is a side cross section of the tank coupling and nozzle coupling of FIG. 8, in a view rotated 90 degrees about the central axis; and

FIG. 10 is a side cross section of the nozzle coupling with the actuator handle in its open position.

### DETAILED DESCRIPTION

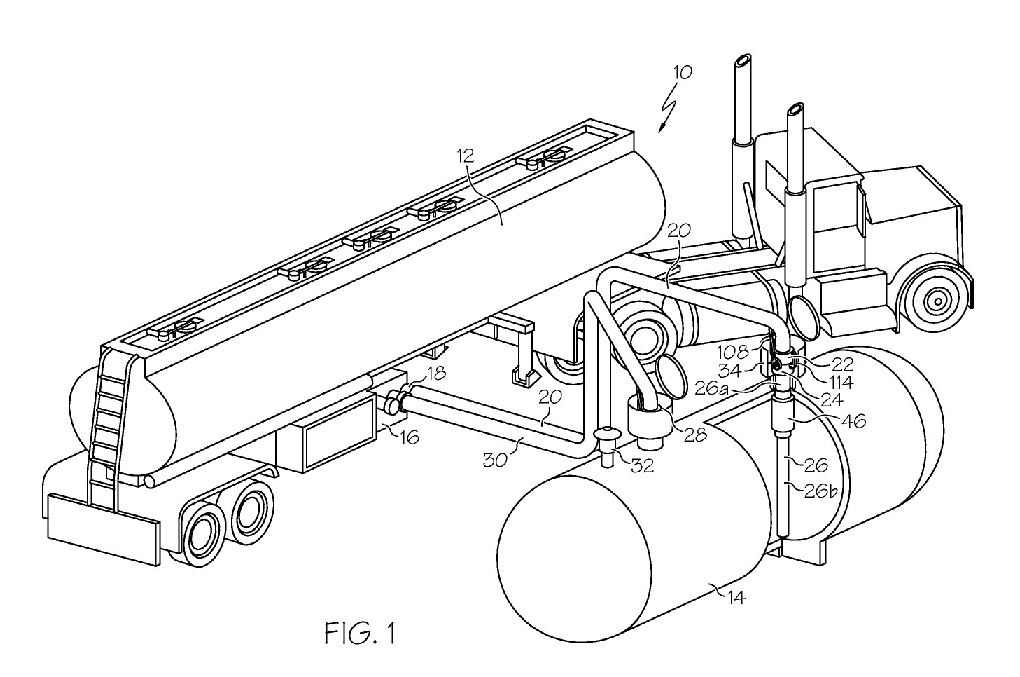

As shown in FIG. 1, a tank truck 10 may be coupled to and configured to pull/transport a refilling tank 12 to any of a variety of desired locations. In FIG. 1 the tank trunk 10 and refilling tank 12 are shown positioned adjacent to a storage tank 14. The refilling tank 12 and storage tank 14 can be utilized to transport/store any of a wide variety of liquids, fluids or fuels, including but not limited to petroleum-based fuels, such as gasoline, diesel, natural gas, biofuels, propane, oil or the like, or ethanol the like. The illustrated tank truck 10 has a pump 16 on its underside for evacuating the contents of the refilling tank 12 through a discharge outlet 18 of the pump 16.

The refilling tank 12 is fluidly coupled to the storage tank 14 via a hose or dispensing line 20. The dispensing line 20 can be threadably or otherwise coupled to the pump 16 at the discharge outlet 18. The dispensing line 20 may include a nozzle coupling 22 at its distal end that is configured to be fluidly and mechanically coupled to a tank coupling 24 at a position above the storage tank 14. In this manner fluid can be pumped from the refilling tank 12, through the dispensing line 20, nozzle coupling 22 and tank coupling 24, and into a fill pipe 26 of the storage tank 14. In the illustrated embodiment the tank coupling 24 is positioned at the top/upper most surface of the storage tank 14 and the fill pipe 26 is oriented generally vertically. The dispensing line 20/refilling tank 12 is thus directly coupled to the tank 14/tank coupling 24 in a so-called “direct fill” configuration wherein fluid exiting the refilling tank 12 flows into the tank 14 without passing through a pump external of the tank truck 10/storage tank 14.

The storage tank 14 may also have a vapor recovery port 28 that is in fluid communication with ullage space of the storage tank 14. A vapor recovery line 30 can be coupled to the vapor recovery port 28 and to the refilling tank 12. In this manner the vapor recovery line 30 returns vapors, that are displaced by the introduction of liquid into the storage tank 14 during refilling, from the storage tank 14 to the refilling tank 12. The storage tank 14 may also include a vent 32 for exhausting gas or vapor to alleviate excess pressure in the storage tank 14.

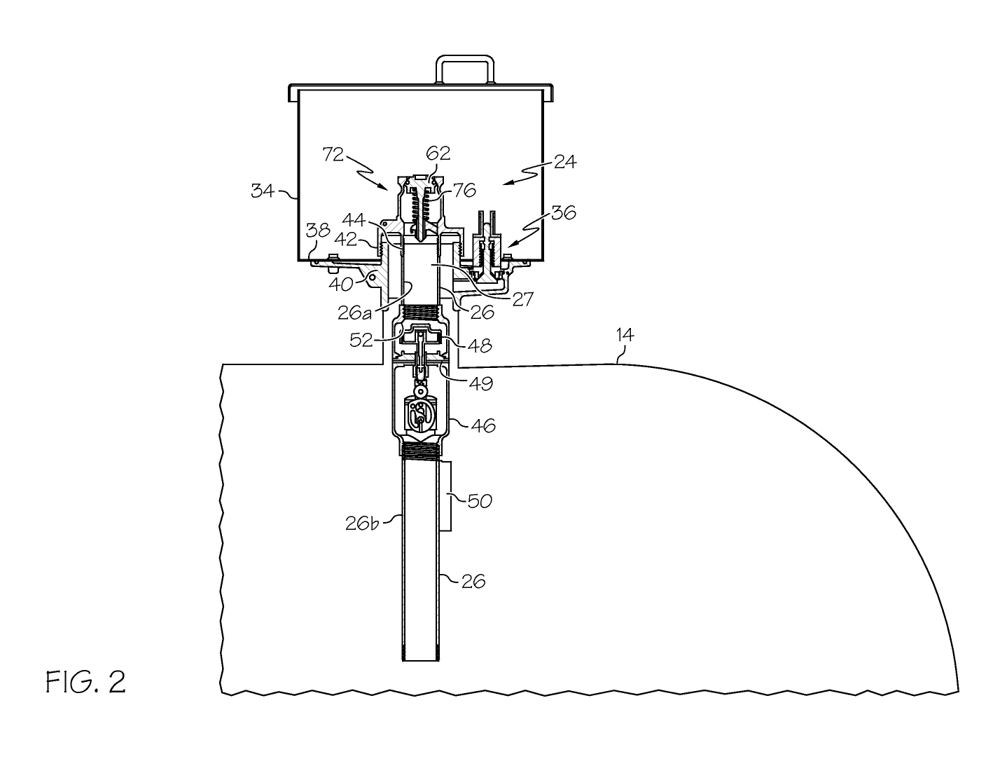

In the embodiment shown in FIGS. 1 and 2, a generally cylindrical spill bucket 34 is positioned on top of the refilling tank 12 and receives the tank coupling 24 therein to contain spills. As shown in FIG. 2, the spill bucket 34 may include a drain valve 36 positioned on or in a bottom panel 38 thereof to allow the refill operator to selectively drain contents of the spill bucket 34 into the tank 14. In the illustrated embodiment, a central component 40 is positioned in, coupled to and extends through the bottom panel 38 of the spill bucket 34 to couple the tank coupling 24 to the spill bucket 34/tank 14. An upper end of the central component 40 is threadably or otherwise coupled to an outer annular flange 42 of the tank coupling 24. The outer annular flange 42 may be formed as a unitary, one-piece component with the body of the tank coupling 24.

In the illustrated embodiment, the fill pipe 26 includes upper 26a and lower 26b fill pipe portions. An upper end of the upper fill pipe portion 26a is threadably or otherwise coupled to an inner annular flange 44 of the tank coupling 24, although the upper fill pipe portion 26a can also be integral with the tank coupling 24 if desired. The lower end of the upper fill pipe portion 26a is threadably or otherwise coupled to an overfill valve 46. An upper end of the lower fill pipe portion 26b is threadably or otherwise coupled to a bottom end of the overfill valve 46 such that the overfill valve 46 is positioned between the upper 26a and lower 26b fill pipe portions, although if desired the fill pipe 26 can take the form of a single continuous pipe.

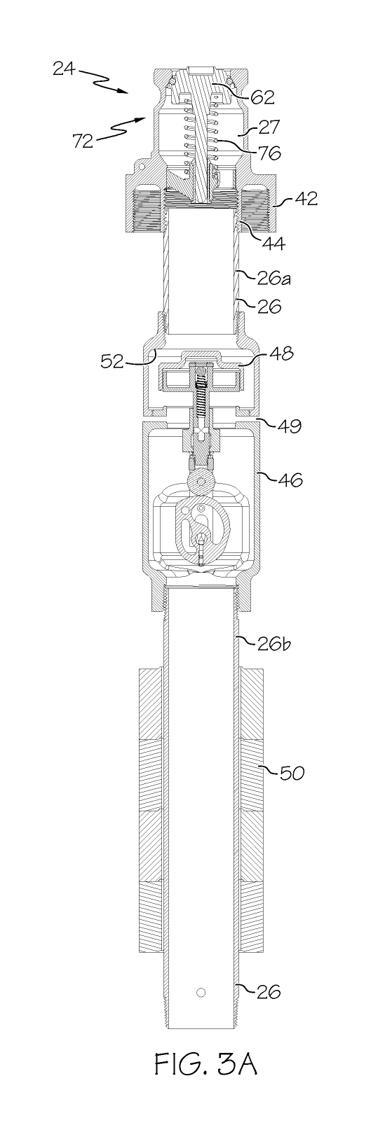

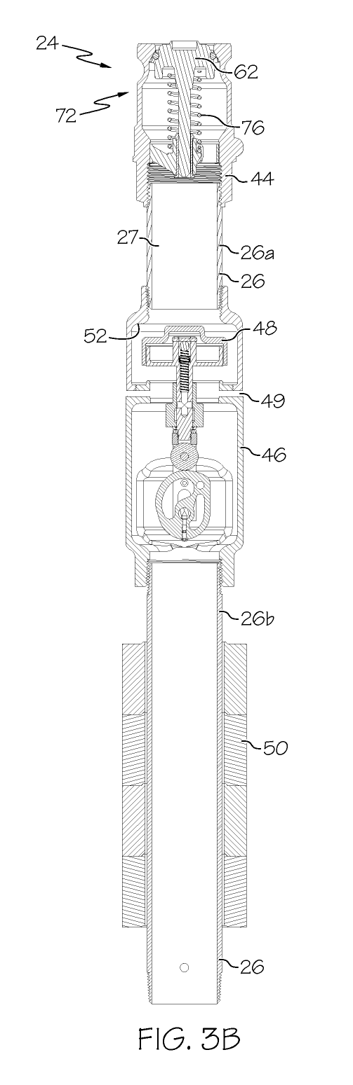

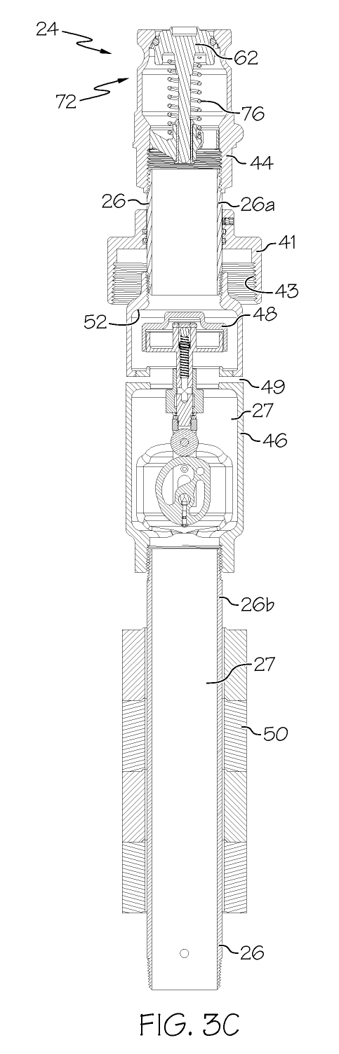

In this arrangement, during refilling fluid flows through the tank coupling 24, the upper fill pipe portion 26a, the overfill valve 46, and finally the lower fill pipe portion 26b and into the tank 14 via a fluid refill path 27. The arrangement of FIG. 2 is shown in greater detail in FIG. 3A and is known as a double tapped dry disconnect coupling. However, it should be understood that the tank coupling 24, spill bucket 34, overfill valve 46, fill pipe 26 and tank 14 can be fluidly and mechanically coupled to each other in a wide variety of manners other than those specifically shown herein without departing from the scope of the invention.

For example, as shown in FIG. 3B, the tank coupling 24 may lack the outer annular flange 42 (i.e. take the form of a single tapped dry disconnect valve) and simply be directly coupled to the upper fill pipe portion 26a/overfill valve 46. As shown in FIG. 3C, a collar 41 may be mounted on the upper fill pipe portion 26a and include an inner threaded surface 43. The inner threaded surface 43 can be threadably coupled to the central component 40 of the spill bucket 34 or to other components. In addition, it should be understood that the terms “top,” “up,” “upper,” “bottom,” “lower,” “below,” and other indications of directionality, are used in conjunction with the particular configuration shown in the drawings. However, it should be understood that the configuration of such components can vary beyond that specifically shown and described herein, and such terminology is used merely for purposes of convenience.

The overfill valve 46 can take any of a wide variety of forms and embodiments. In one case the overfill valve 46 may take the form of the valve disclosed in U.S. Pat. No. 5,850,844, the entire contents of which are incorporated by reference herein. In general, however, the overfill valve 46 may include a blocking portion 48 which is movable between open position, allowing the flow of fluid therethrough (and through the fluid refill path 27), and a closed position, generally blocking the flow of fluid therethrough (and through the fluid refill path 27). The blocking portion 48 is operatively coupled to a float 50. When the float 50 is in its lower position (i.e., when fluid levels in the tank 14 are sufficiently low), the blocking portion 48 remains in its open position. When the float 50 is moved upwardly, such as by the presence of surrounding fuel, fluid or liquid, the float 50 is raised and shifts the blocking portion 48 to the closed position. In the closed position the blocking portion 48 generally forms a seal with the valve seat 52 to prevent further fluid from flowing through the valve 46/fluid refill path 27 and to prevent further fluid from entering the tank 14/lower fill pipe portion 26b.

In some embodiments, the overfill valve 46 includes a path of fluid communication therethrough (particularly when the overfill valve 46 is open), such as via the passageway 49 schematically shown in FIGS. 2 and 3A-3C. If not otherwise sealed (i.e. when the blocking portion 48 is in its lower position), the overfill valve 46 can thus allow vapor to enter the fluid refill path 27 and escape from the tank 14 to the ambient atmosphere. Some nozzle couplings 24 may include a dust cap held in place by dust cap retaining arms which provide some limited blocking of vapors escaping through the upper fill pipe portion 26a. However, a dust cap does generally not provide a sufficiently fluid-tight/vapor tight seal, and must be manually removed for refilling and manually replaced after refilling and thus does not function as a valve. The nozzle coupling 22 and in some cases the tank coupling 24 disclosed herein help to provide a sealed arrangement to block the escape of vapors from the tank 14 when the overfill valve 46 is in its open position. However, it should be understood that the nozzle coupling 22 and tank coupling 24 disclosed herein can be used in any of a wide variety of systems including in conjunction with various overfill valves different from the particular overfill valve 46 shown herein, and could also be used in systems lacking any overfill valves.

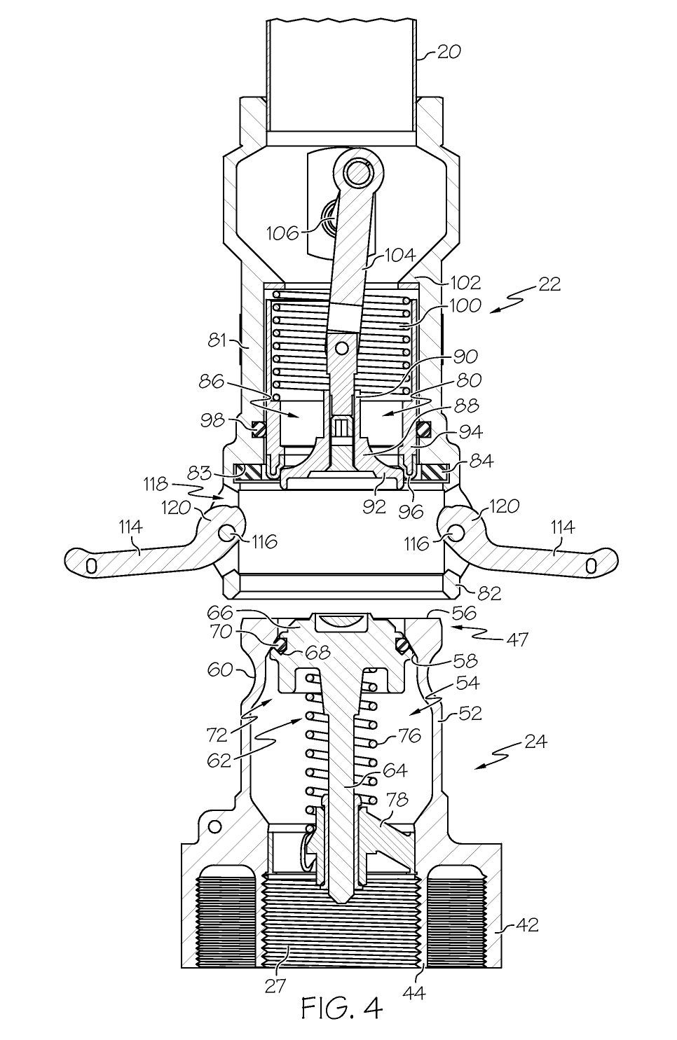

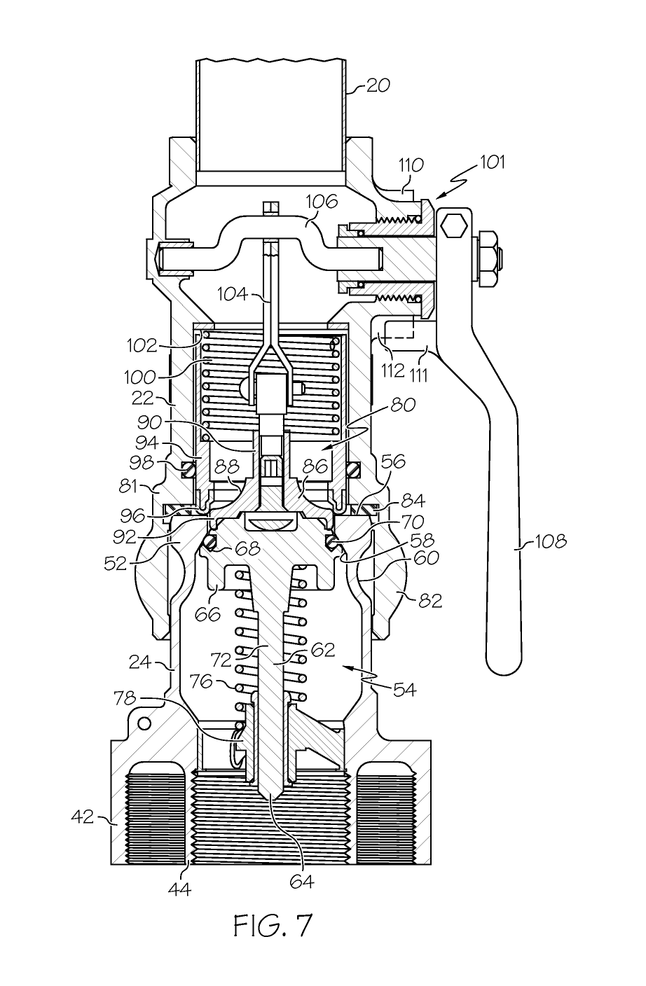

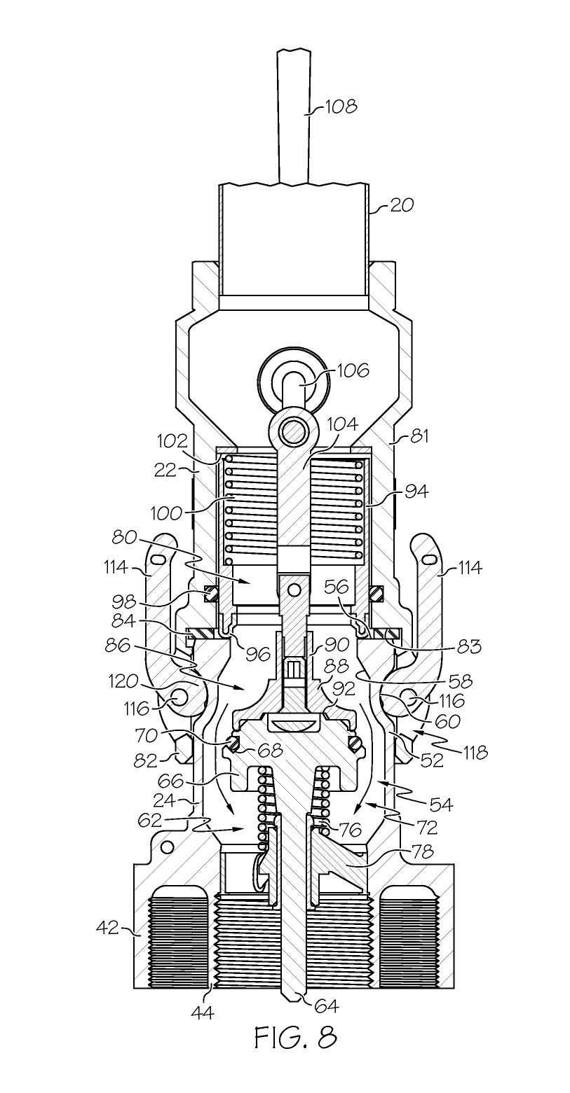

With reference to FIG. 4, the tank coupling 24 may include a generally annular/cylindrical body 52 defining an inner main cavity 54. A upper end 47 of the body 52 forms a generally flat engagement surface 56, and a valve seat 58 (see FIGS. 7 and 8) is positioned on the radially inner surface of the upper end 47. The body 52 of the tank coupling 24 includes an smooth or curved annular groove or recess 60 on its outer surface on or adjacent to the upper end 47. The recess 60 is utilized to couple the nozzle coupling 22 to the tank coupling 24, as will be described in greater detail below. The recess 60 may extend annularly about the body 52 of the tank coupling 24 such that the tank coupling 24 and nozzle coupling 22 can be coupled together at any angular position.

A reciprocable poppet member 62 is received in the main cavity 54. The poppet member 62 includes a generally axially-extending stem 64 and a relatively flat head 66 at the upper/distal end of the stem 64. The head 66 has a groove 68 formed thereon which receives an O-ring 70 or the like therein. The O-ring 70/poppet member 62 is configured to sealingly engage the valve seat 58 when the poppet member 62 is closed, as shown in FIG. 4, to thereby form a tank coupling poppet valve or blocking valve 72. A compression spring 76 is positioned on the underside of the poppet member 62 to bias the tank coupling poppet valve 72 into its closed position. The tank coupling 24 includes a poppet guide 78 positioned in the main cavity 54. The guide 78 closely slidably receives the stem 64 of the poppet member 62 therethrough to guide reciprocal movement of the poppet member 62.

The nozzle coupling 22 includes a generally annular/cylindrical body 81 defining an inner cavity 80. The body 81 includes a flange 82 configured to closely receive the body 52 of the tank coupling 24 therein. An annular seal 84 is positioned at the base of the flange 82 adjacent to lip 83 to aid in forming a seal with the tank coupling 24, as will be described in greater detail below. The nozzle coupling 22 is threadably or otherwise coupled to the dispenser line 20 at its upper end thereof such that the inner cavity 80 of the nozzle coupling 22 is in fluid communication with the dispenser line 20.

The nozzle coupling 22 further includes a poppet valve 86 including a reciprocable poppet member 88 positioned in the inner cavity 80. The poppet member 88 includes a generally axially-extending stem 90 and a relatively flat head 92 at the lower/distal end of the stem 90. The nozzle coupling 22 includes a follower sleeve 94 generally receiving the poppet member 88 therein. An annular sleeve seal 96 is positioned about the lower end of the sleeve 94 to form a seal with the upper/outer surface of the poppet member 88. An O-ring 98 or the like may be positioned between the sleeve 94 and the nozzle coupling body 81 to aid in forming a fluid-tight and sealed connection therebetween. A sleeve compression spring 100 is positioned between the sleeve 94 and a rib 102 of the nozzle coupling body 81 to spring bias the sleeve 94 in the downward/closed direction. In this manner, the sleeve 94 and sleeve seal 96 are spring biased against the top surface of the poppet member 88 thereby forming a seal therewith and preventing fluid from exiting the nozzle coupling 22.

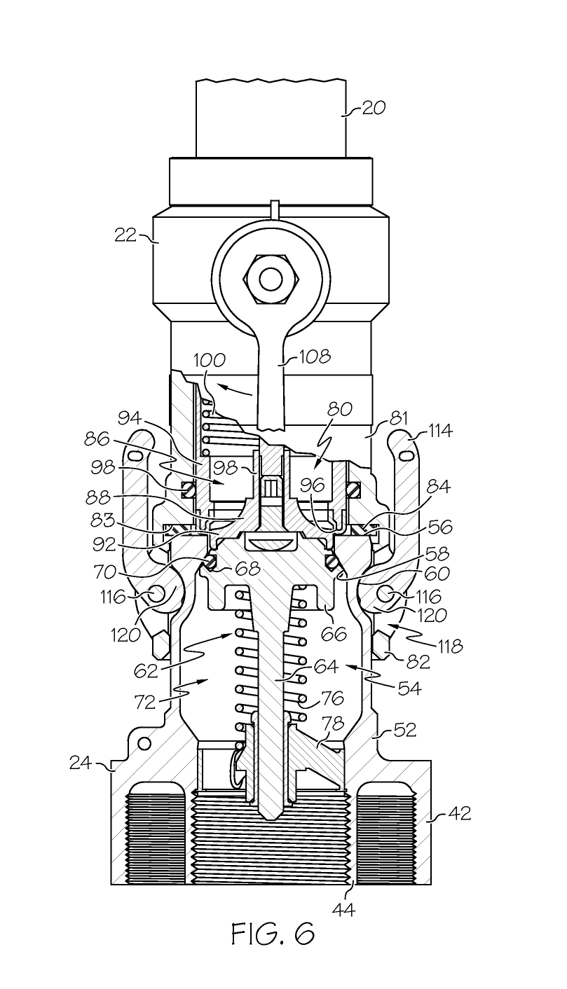

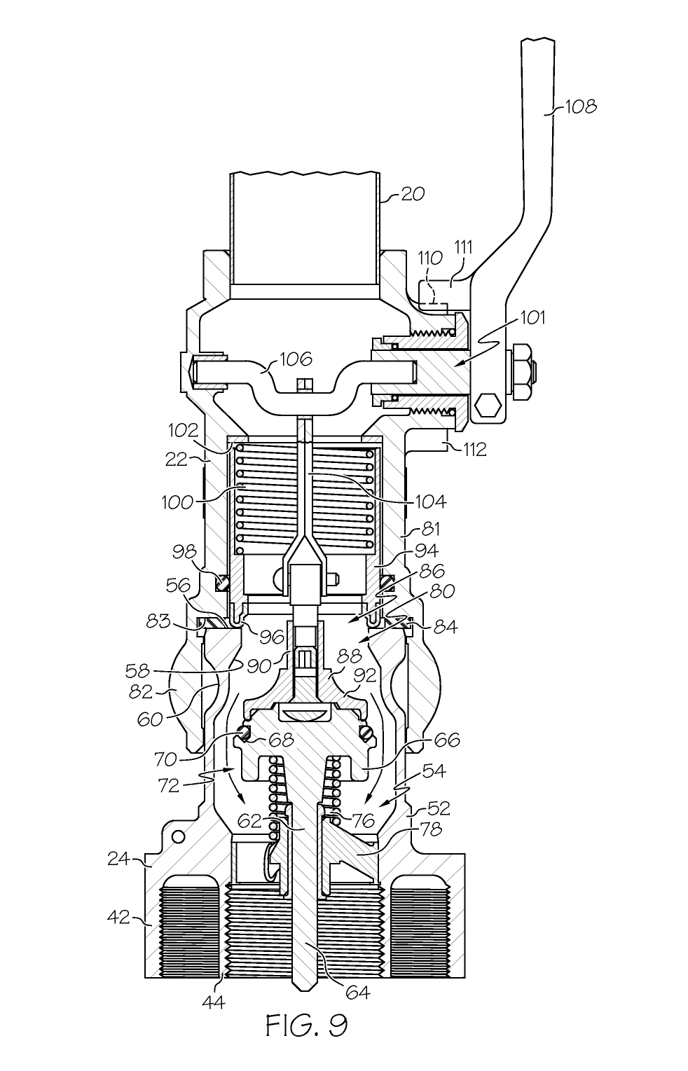

The upper or distal end of the poppet member 88 is coupled to a linkage 104 which is, in turn, coupled to a cam shaft 106 (best shown in FIGS. 7, 9 and 10). The cam shaft 106 is, in turn, coupled to an actuator handle 108 via a fluid-tight coupling 101. The actuator handle 108 is rotatable between a closed position (FIGS. 6 and 7, extending downwardly in the illustrated embodiment) and an open position (FIGS. 8 and 9, extending upwardly in the illustrated embodiment), as will be described in greater detail below. The body 81 of the nozzle coupling 22 may have a stop 110 which interacts with a knob 111 of the actuator handle 108 to limit motion of the actuator handle 108 once it reaches the open position. Conversely, the body 81 may include another stop 112 which interacts with the knob 111 to limit motion of the actuator handle 108 once the handle 108 reaches the closed position.

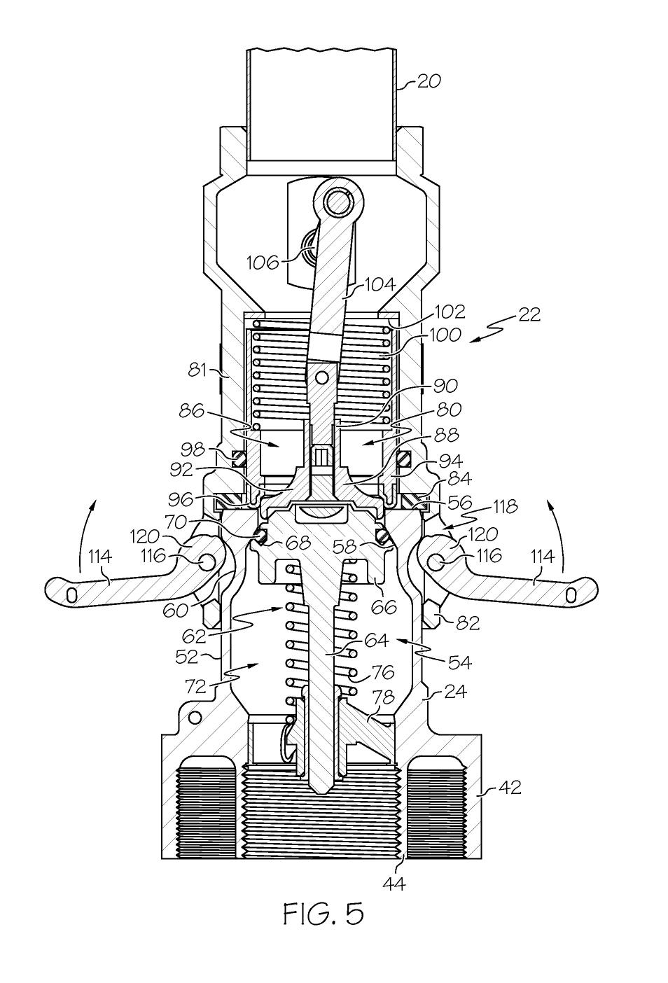

The nozzle coupling 22 includes a pair of opposed locking arms 114 at or adjacent to its lower end thereof. Each locking arm 114 is pivotable about an associated pivot point 116, and extends through an associated opening 118 of the body 81/flange 82, as will be described in greater detail below. Each locking arm 114 has a lobe 120 which is spaced away from the associated opening 118 when the associated handle 114 is in the retracted position, as shown in FIGS. 4 and 5.

In the position illustrated in FIG. 4, the poppet member 88 is generally sealingly engaged with the sleeve 94 as described above to prevent fluid from escaping from the nozzle coupling 22. In addition, the poppet member 62 of the tank coupling 24 is spring biased against the valve seat 58, thereby providing a seal to the tank coupling 24 and preventing the escape of vapors or other fluid. Thus the poppet member 62 is positioned above or upstream of the overfill valve 46 (with respect to the direction of fluid flow).

In order to couple the nozzle coupling 22 and tank coupling 24, and allow fluid to flow from the dispenser line 20 into the storage tank 14, the nozzle coupling 22 is first slid over the tank coupling 24 so that the flange 82 of the nozzle coupling 22 generally closely receives the outer surface of the body 52 of the tank coupling 24 therein, as shown in FIG. 5. Once the nozzle coupling 22 is fully seated over the tank coupling 24, the seal 84 of the flange 82 of the nozzle coupling 22 contacts, or is positioned adjacent to, the engagement surface 56 of the tank coupling 24.

In addition, when in this position each locking arm 114 of the nozzle coupling 22 is axially aligned with the recess 60 of the tank coupling 24. Each locking arm 114 is then pivoted about its pivot point 116 (as shown by the arrows in FIG. 5) until each arm 114 is in its engaged position. As each locking arm 114 is moved from its retracted position (FIG. 5) to its engaged position (FIG. 6) the lobe 120 of each locking arm 114 is urged through the associated opening 118 of the nozzle coupling 24 and into the recess 60 of the tank coupling 24 to securely couple the nozzle coupling 22 to the tank coupling 24. Moreover, as each lobe 120 is pressed into the recess 60, the lobe 120 engages the recess 60 with a camming action, thereby pulling the nozzle coupling 22 and tank coupling 24 together in the axial direction. Thus, proper use of the locking arms 114 causes the engagement surface 56 to compress the seal 84, thereby providing a tight seal between the nozzle coupling 22 and tank coupling 24.

Once the locking arms 114 are engaged, the poppet members 62, 88 are immediately adjacent to each other, or even slightly touching. Moreover, in the illustrated embodiment the poppet members 62, 88 have complementary shapes that allow the poppet members 62, 88 to fit closely together. In addition, the engagement surface 56 is immediately adjacent to, or even slightly touching, the sleeve seal 96. However, the sleeve seal 96 and poppet member 88 may still form a seal therebetween.

Next, in order to open the poppet valves 72, 86 and allow fluid to flow therethrough, the actuator handle 108 is rotated from the closed position (FIGS. 6 and 7) to the open position (FIGS. 8 and 9). When the actuator handle 108 is moved to the open position, the handle 108 rotates the cam shaft 106, which in turn urges the central portion of the linkage 104 and poppet member 88 downwardly. Downward movement of the poppet member 88 causes the poppet member 88 to engage the upper surface of the poppet member 62, thereby causing both poppet members 88, 62 to move downwardly to their positions shown in FIGS. 8 and 9. Thus, movement of the poppet member 88 downwardly causes the poppet member 62 to move away from, and thereby unseal relative to, the valve seat 58, compressing the spring 76.

Downward movement of the poppet member 88 also causes the poppet member 88 to move away from the sleeve 94. More particularly, as noted above, the sleeve 94 is positioned immediately adjacent to the engagement surface 56 of the tank coupling 24, which blocks any attempted downward movement of the sleeve 94 as urged by the spring 100. In addition, the sleeve seal 96 is pressed into contact with the engagement surface 56 by the spring 100 to form a seal with the engagement surface 56 to contain fluid in the couplings 22, 24 (in addition to the seal provided by seal 84 described above). Thus, in the open position shown in FIGS. 8 and 9, the poppet member 88 is separated from, and thereby unsealed relative to, the follower sleeve 94. In the position shown in FIGS. 8 and 9 both the poppet valves 72, 86 are open and fluid can flow around the poppet members 88, 62 (as shown by the arrows) and enter the fill pipe 26 and tank 14.

When refilling is complete and it is desired to uncouple the tank coupling 24 and nozzle coupling 22, the actuator handle 108 is rotated in the opposite direction thereby causing the crank shaft 106 and linkage 104 to return the poppet member 88 to its position shown in FIGS. 6 and 7. In this position, the poppet member 88 again forms a seal with the sleeve 94. Additionally, the poppet member 62 of the tank coupling 24 returns to its closed position as urged by the spring 76 and sealingly engages the seat 58. The locking arms 114 are then moved to their disengaged position shown in FIG. 5, and the tank coupling 24 and nozzle coupling 22 can be separated, as shown in FIG. 4.

The nozzle coupling 22 and tank coupling 24 disclosed herein provide several significant advantages. Initially, it is noted that the tank coupling 24 remains closed and sealed when no refilling operations are being conducted. In particular, as shown in FIG. 4 the poppet valve 72 remains closed, and increased pressure in the tank 14 only further seals the poppet valve 72. In this manner, the nozzle coupling 24 prevents the escape of vapors from the tank 14 into the atmosphere.

In addition, the actuator handle 108 is utilized to move the poppet valves 86, 72 of the nozzle coupling 22 and tank coupling 24 to their open positions, and the poppet valves 86, 72 are maintained in their open positions until closed by the actuator handle 108. Thus, pressure of the dispensed fluid is not required to open, or keep open, the valves 86, 72. This particular arrangement reduces pressure drop and ensures an always-opened, positively-opened fluid flow path to reduce work required by the pump 16, and allows even relatively low pressure flow to pass through the nozzle coupling 22 and tank coupling 24.

In addition, the tank coupling 24 and nozzle coupling 22 provide a relatively low-fluid-loss, or “dry” coupling. In particular, once refilling is completed and the poppet valves 86, 72 are returned to their closed positions shown in FIGS. 6 and 7, it can be seen that there is very little space, if any, between the poppet members 88, 62 in which fluid can be trapped, due to their close engagement and complementary shapes. Thus, separation of the tank coupling 24 and nozzle coupling 22 after refilling results in very little volume of fluid being lost, which reduces messy spills and the escape of vapors into the environment. However, other couplings in which greater fluid loss can be experienced can also be utilized in the system disclosed herein.

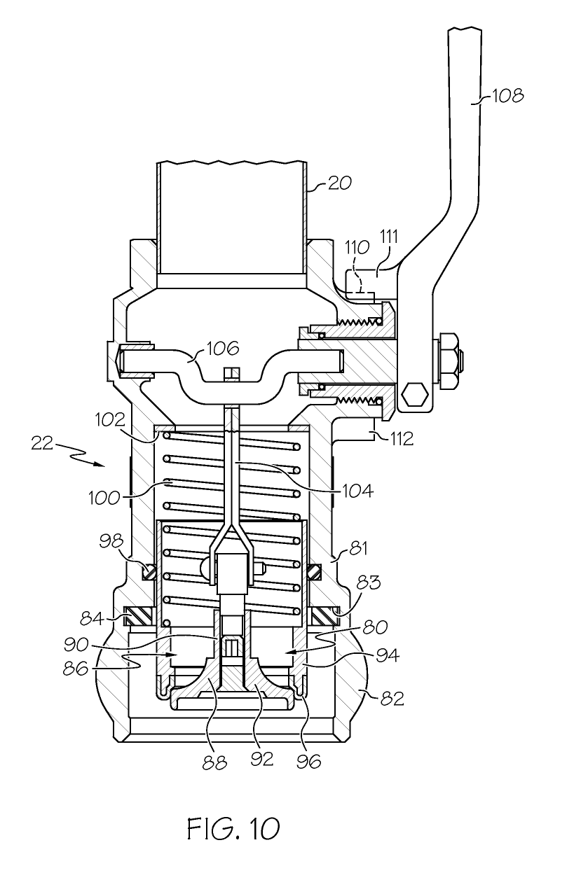

The particular coupling system disclosed herein is configured such that should the locking arms 114 be inadvertently opened, or for some other reason the nozzle coupling 22 and tank coupling 24 were to be separated (i.e., during refilling operations), fluid loss would be limited. In particular, if the nozzle coupling 22 and tank coupling 24 were in their state shown in FIGS. 8 and 8 and were to become axially separated, the follower sleeve 94 would immediately move downwardly (as biased by the spring 100) to sealingly engage the top side of the poppet member 88 (i.e., the sleeve 94 would move to its position shown in FIG. 10), even if the poppet member 88 was extended. Simultaneously, the poppet member 66 would be moved to its sealed position as urged by the spring 76 (shown in FIG. 4). Thus, a dry break by both the tank coupling 24 and the nozzle coupling 22 is provided, even under adverse conditions.

Moreover, should the actuator handle 108 of the nozzle coupling 22 be accidentally moved to its open position (i.e., when the nozzle coupling 22 is not coupled to the tank coupling 24), the nozzle coupling 22 remains closed/sealed. In particular, as shown in FIG. 10, if the actuator handle 108 were to be opened in this situation, the poppet member 88 is moved downwardly, but the follower sleeve 94 follows the poppet 88 as biased by the spring 100 and maintains its seal therewith. Accordingly, should a user inadvertently or accidentally turn the actuator handle 108 when the nozzle coupling 22 is not coupled to the tank coupling 24, the poppet valve arrangement 86 shown therein still prevents the escape of fluid from the nozzle coupling 22. It is only when the nozzle coupling 22 is properly engaged with the tank coupling 24 that the sleeve 94 is prevented from following the poppet member 88, and fluid is allowed to flow therethrough. In addition, in the configuration shown in FIG. 10, the nozzle coupling 22 cannot be coupled to the tank coupling 24 due to the interference provided by the protruding sleeve 94. This feature ensures that the nozzle coupling 22 can only be coupled to the tank coupling 24 when the actuator handle 108 is in its closed position.

It may be desired that, upon movement of the actuator handle 108 from its closed to its open position, the couplings 22, 24 are configured such that the poppet members 62, 88 engage/contact each other prior to the poppet member 62 unseating from its valve seat 58, and prior to poppet member 88 separating from its sleeve seal 96. This arrangement helps to minimize the amount of fluid is trapped between the poppet member 62, 88 to ensure a dry coupling. If desired, one or both of the poppet members 62, 88 may be axially adjustable to ensure that proper engagement in this manner is maintained.

Accordingly, the use of the coupling system disclosed herein ensures that the tank 14/fill pipe 26 is closed and sealed during normal conditions (i.e., when not being refilled). Moreover, when refilling takes place, the poppet valves 72, 86 of the tank coupling 22, and nozzle coupling 24 are positively opened by forces other than fluid pressure (i.e., manually opened in the illustrated embodiment, although the poppet valves 72, 86 could be opened by other sources of power). In this manner, the refilling liquid/fluid is not required to open the poppet valves 72, 86 and/or retain the poppet valves 72, 86 in an open position. Thus, the tank coupling reduces pressure drop thereacross which, in turn, reduces work required by the pump 16 during refilling operations and provides a more reliable, robust valve system, and provides a sealed connection to prevent the escape of vapor.

However, it should be understood that any of a variety of valves, besides the poppet valve 72 shown herein, can be utilized to prevent the escape of vapor from the tank 14. For example, if desired a check valve or the like, which is not necessarily positively opened by the upper poppet 88, can be utilized in place of the poppet valve 72. In this case, the check valve or other valve may be opened by the flow of refilling fluid, but may have a relatively weak spring so that there is a relatively low pressure drop across the check valve in this case. This arrangement ensure that vapors do not escape from the tank 14 via the overfill valve 46. In addition, the valve 72 shown herein can be used alone, and without the positive opening of the valve 72 provided by the nozzle coupling 22, if desired, resulting in a simpler arrangement. Any of a wide variety of valve arrangements, including check valves, poppet valves, ball valves, butterfly valves, diaphragm valves, plug valves, gate valves, etc. may be utilized in place of the poppet valve 72. In general, these valves may be configured to generally block, seal or close the tank/14 fluid refill path 27 outside of refill operations to prevent the escape of vapors, and allow the flow of fluid therethrough during refill operations.

Moreover, it should be understood that the positions of the tank coupling 24 and nozzle coupling 22 disclosed herein can be reversed; that is, the tank coupling 24 can be positioned at the end of the dispensing line 20, and the nozzle coupling 22 can be fixedly coupled to the tank 14. In addition, the actuator handle 108 and cam shaft 106 can be positioned on the tank coupling 24 and utilized to pull the poppet member 88 of the nozzle coupling 22 downwardly into engagement with the poppet member 66. The tank coupling 22 and nozzle coupling 24 may have a configuration and operation similar to that as shown in U.S. Pat. No. 3,473,569, the entire contents of which are incorporated herein by reference, although the particular configuration and use shown herein differs. In addition, the positioning of the tank coupling 24 on top of the tank 14 (i.e. in a vertical configuration) for direct-fill operations provides certain benefits, such as sealing the fill pipe 26 to prevent the escape of vapor therefrom.

Although the invention is shown and described with respect to certain embodiments, it should be clear that modifications will occur to those skilled in the art upon reading and understanding the specification, and the present invention includes all such modifications.

What is claimed is:

1. A tank assembly comprising:
a tank for storing fluid, said tank having a fluid refill path;
a blocking valve coupled to said tank, said blocking valve being positioned in said fluid refill path and configured to selectively generally seal said fluid refill path; and
an overfill valve in fluid communication with said fluid refill path and configured to generally block said fluid refill path when sufficient fluid is in said tank, wherein said blocking valve is positioned to prevent vapors which are introduced into said fluid refill path via said overfill valve from escaping from said tank.

2. The tank assembly of claim 1 wherein said blocking valve includes a poppet valve spring biased to a closed position wherein said blocking valve fluidly seals said fluid path.

3. The tank assembly of claim 1 wherein said overfill valve when open provides a path of fluid communication between said refill path and an ullage space of said tank to thereby introduce vapors into said fluid refill path.

4. The tank assembly of claim 1 wherein said tank includes a generally vertically oriented fill pipe positioned therein and at least partially defining said fluid refill path, and wherein said blocking valve and said overfill valve are in fluid communication with said fill pipe, and wherein said blocking valve is positioned above said overfill valve.

5. The tank assembly of claim 1 wherein said blocking valve is movable between a closed position, wherein said blocking valve generally seals said fluid refill path, and an open position wherein said blocking valve does not generally seal said fluid refill path, and wherein said blocking valve is configured to be moved from said closed position to said open position by a force other than a pressure of fluid flowing through said fluid refill path.

6. The tank assembly of claim 5 wherein said blocking valve is configured to be manually moved from said closed position to said open position.

7. The tank assembly of claim 5 further comprising a nozzle coupling releasably coupled to said tank, said nozzle coupling being coupled to a fluid delivery line for delivering fluid to said tank via said fluid refill path, and wherein said nozzle coupling includes an actuator which is manually operable to move said blocking valve from said closed position to said open position.

8. The tank assembly of claim 1 further comprising a tank coupling fixedly coupled to said tank and a nozzle coupling fixedly coupled to a fluid source, wherein said tank coupling and said nozzle coupling are removably coupled together and in fluid communication to enable fluid to flow through said nozzle coupling and said tank coupling, into said fluid refill path and into said tank, and wherein said blocking valve is positioned in said tank coupling.

9. The tank assembly of claim 8 wherein said nozzle coupling includes a poppet and a sleeve sealingly biased against said poppet to generally block the flow of fluid through said nozzle coupling when said sleeve engages said poppet.

10. The tank assembly of claim 9 wherein said poppet of said nozzle coupling is movable to an extended position in which said poppet engages said blocking valve and causes said blocking valve to move to an open position in which said blocking valve allows the flow of fluid therethrough.

11. The tank assembly of claim 10 wherein when said poppet is in said extended position said poppet is spaced away from said sleeve to allow the flow of fluid therebetween.

12. The tank assembly of claim 10 wherein said sleeve is spring biased to sealingly engage said tank coupling when said poppet is moved to said extended position.

13. The tank assembly of claim 10 wherein said sleeve is biased and configured to sealingly engage said poppet when said poppet is in said extended position and when said nozzle coupling is not removably coupled to said tank coupling.

14. The tank assembly of claim 1 wherein said blocking valve is movable between a closed position, wherein said blocking valve generally seals said fluid refill path, and an open position wherein said blocking valve does not generally seal said fluid refill path, and wherein said blocking valve is configured to be moved from said closed position to said open position by a pressure of fluid flowing therethrough.

15. A coupling system comprising a tank coupling coupled to a tank and configured to be coupled to a nozzle coupling to allow fluid to flow therethrough and into said tank, wherein said tank coupling includes a tank coupling valve movable between a closed position in which said tank coupling valve generally blocks the flow of fluids therethrough and an open position in which said tank coupling valve generally does not block said flow of fluids therethrough, wherein said tank coupling valve is configured to be moved from said closed position to said open position by a force other than a pressure of fluid flowing therethrough.

16. The coupling system of claim 15 wherein said tank coupling valve is configured to be manually moved from said closed position to said open position.

17. The coupling system of claim 15 further comprising said nozzle coupling releasably coupled to said tank coupling, said nozzle coupling being coupled to a fluid delivery line for delivering fluid to said tank, and wherein said nozzle coupling includes an actuator which is manually operable to move said tank coupling valve from said closed position to said open position.

18. The coupling system of claim 15 wherein said tank coupling is directly coupled to a top of said tank.

19. The coupling system of claim 15 wherein said tank has a fluid refill path, and wherein said tank coupling valve is positioned in said fluid refill path, and wherein the coupling system further includes an overfill valve in fluid communication with said fluid refill path to generally block said fluid refill path when sufficient fluid is in said tank, wherein said tank coupling valve is positioned to prevent vapors which are introduced into said fluid refill path via said overfill valve from escaping from said tank into the ambient environment.

20. The coupling system of claim 15 wherein said tank coupling is removably coupled to said nozzle coupling, which is in turn fluidly coupled to a fluid delivery line for delivering fluid to said tank.

21. The coupling system of claim 20 wherein said tank coupling valve includes a tank poppet spring biased to said closed position, and wherein said nozzle coupling includes a nozzle poppet and a sleeve sealingly biased against said nozzle poppet.

22. The coupling system of claim 21 wherein said nozzle poppet is movable to an extended position in which said nozzle poppet engages and moves said tank poppet, thereby causing said tank coupling valve to move to said open position.

23. The coupling system of claim 21 wherein said sleeve is biased and configured to sealingly engage said nozzle poppet when said nozzle poppet is in said extended position and when said nozzle coupling is not removably coupled to said tank coupling.

24. A method for filling a tank comprising the steps of:
accessing a tank assembly including a tank for storing fluid, the tank having a fluid refill path, the tank assembly further including a tank coupling coupled to said tank and having blocking valve positioned in said fluid refill path, wherein said blocking valve is in a closed position generally sealing said fluid refill path;
accessing a nozzle including a nozzle coupling in fluid communication with a fluid source;
releasably coupling said nozzle coupling to said tank coupling;
causing said blocking valve to move away from said closed position; and
causing fluid to flow through said fluid delivery line, said nozzle coupling and said tank coupling into said fluid refill path.

25. The method of claim 24 wherein said first causing step includes manually operating an actuator positioned on said nozzle which causes said blocking valve to move away from said closed position.

26. The method of claim 24 wherein said tank assembly further includes a shut-off valve configured to generally block said fluid refill path when sufficient fluid is in said tank, wherein said shut-off valve enables vapors from said tank to be introduced into said fluid refill path, and wherein said blocking valve is positioned to prevent said vapors introduced into said fluid refill path from escaping from said tank.

27. The method of claim 24 wherein said tank coupling is directly coupled to a top of said tank, and wherein said fluid refill path is at least partially defined by a generally vertically oriented fill pipe positioned in said tank.
